(19) United States
(12) Patent Application Publication
(10) Pub. No.: US 2012/0214021 A1
(43) Pub. Date: Aug. 23, 2012

(54) MAGNETIC RECORDING MEDIUM AND MAGNETIC RECORDING APPARATUS

(75) Inventors: Junichi Sayama, Fujisawa (JP); Ikuko Takekuma, Yokohama (JP); Hiroaki Nemoto, Odawara (JP)

(73) Assignee: Hitachi, Ltd.

(21) Appl. No.: 13/364,682

(22) Filed: Feb. 2, 2012

(30) Foreign Application Priority Data
Feb. 23, 2011 (JP) 2011-037408

(51) Int. Cl. G11B 5/65

(52) U.S. Cl. 428/836.1

(57) ABSTRACT

There is provided a magnetic recording medium including an MgO underlayer that can be formed by a mass production process and has a thickness of 3 nm or less as well as including a magnetic recording layer made of an L1₀-type FePt ordered alloy having excellent magnetic properties. A conductive compound having a crystal structure belonging to a cubic system is used as a material of an underlayer provided at the bottom of the MgO underlayer. The thickness of the MgO layer is 1 nm or more and 3 nm or less.

### CLAIM OF PRIORITY

The present application claims priority from Japanese patent application JP 2011-037408 filed on Feb. 23, 2011, the content of which is hereby incorporated by reference into this application.

### BACKGROUND OF THE INVENTION

1. Field of the Invention

The present invention relates to a magnetic recording medium.

2. Background Art

A large capacity magnetic recording apparatus, namely, a high density magnetic recording medium has been achieved by decreasing the size of ferromagnetic crystal grains forming a magnetic recording layer of the magnetic recording medium. However, when the size of ferromagnetic crystal grains are decreased, the magnetic anisotropy energy (the product of the magnetic anisotropy energy per unit volume (magnetic anisotropy constant) of the ferromagnetic crystal grains and the volume of the ferromagnetic crystal grains) of the ferromagnetic crystal grains is small relative to the atomic thermal vibration energy (product of the Boltzmann constant and the absolute temperature), so that the ferromagnetic crystal grains cannot maintain stable recording magnetization. This phenomenon is called the thermal fluctuation of magnetization, which is a major factor for determining the physical limitation of recording density.

Suppression of the thermal fluctuation of magnetization requires the use of a material having an essentially high magnetic anisotropy constant to form the magnetic recording layer. The magnetic recording layer has been made mainly of a Co—Cr based alloy for a long period of time (see JP Patent Publication (Kokai) No. 60-214417 A (1985)). Note that the magnetic anisotropy constant of the Co—Cr based alloy has been said to be unable to cope with recording densities in excess of 1 Tbit/inch². Accordingly, in order to cope with a demand for high density magnetic recording media, a material having a higher magnetic anisotropy constant than that of the Co—Cr based alloy needs to be used.

In order to solve this problem, an ordered alloy which is an alloy of a transition metal element (Fe, Co, Ni, etc.) and a noble metal element (Pt, Pd, etc.), and has a structure in which atomic layers having different element compositions are alternately ordered has been proposed as a new material for the magnetic recording layer (see JP Patent Publication (Kokai) No. 2002-216330 A, JP Patent Publication (Kokai) No. 2004-213869 A, and JP Patent Publication (Kokai) No. 2010-34182 A). Such an alloy has a very high magnetic anisotropy constant and thus is suitable for the material of the magnetic recording layer of a high density magnetic recording medium.

An L1₀-type ordered alloy consisting of equiatomic Fe and Pt has a particularly high magnetic anisotropy constant among the ordered alloys, and hence is particularly suitable for the material of the magnetic recording layer.

FIG. 1 illustrates a crystal structure of an L1₀-type FePt ordered alloy. The crystal structure has an ordered arrangement in which a Fe atomic layer and a Pt atomic layer are alternately arranged and is characterized in that [100] axis is longer than [001] axis. The L1₀-type FePt ordered alloy exhibits a magnetic anisotropy with a crystal axis direction ([001] axis) perpendicular to each atomic layer as an easy axis of magnetization. Thus, formation of a thin film with this [001] axis oriented perpendicular to the film surface allows the L1₀-type FePt ordered alloy to be used for a perpendicular magnetic recording medium.

Even an alloy consisting of equiatomic Fe and Pt but a disordered alloy having no atomic ordered arrangement has a crystal structure of a cubic system with each crystal axis equal in length (=3.813 Angstrom). Such a disordered alloy does not exhibit a magnetocrystalline anisotropy at all. An ordered alloy is obtained by forming a disordered alloy and then annealing it or forming a disordered alloy on a substrate pre-heated to a high temperature. That is, in order to obtain an ordered alloy, the heating treatment followed by a disorder-order phase transition (ordering) is required. The heating process of causing a phase transition to an L1₀-type FePt ordered alloy needs to be performed at a temperature in excess of about 300° C.

A method of using MgO for an underlayer is widely used as means of orienting the axis of a thin film of the L1₀-type FePt ordered alloy perpendicular to the film surface.

FIG. 2 illustrates a crystal structure of MgO. MgO has a crystal structure of a cubic system as illustrated in the figure. When a thin film is formed of MgO, the crystalline orientation is determined so as to minimize the surface energy and the [001] axis is preferentially oriented perpendicular to the film surface. The L1₀-type FePt ordered alloy and MgO have similar crystal structures. Thus, when the L1₀-type FePt ordered alloy is deposited on MgO, the crystalline orientation is controlled so as to mutually align the crystal axes.

Here, as illustrated in FIG. 1 and FIG. 2, the [100] axis of the L1₀-type FePt ordered alloy is longer than the [001] axis thereof, and the [100] axis of MgO is further longer than the axis of the L1₀-type FePt ordered alloy. Accordingly, the [100] axis of the L1₀-type FePt ordered alloy is the crystal axis that is preferentially aligned with the [100] axis of MgO. As a result, a thin film with the [001] axis of the L1₀-type FePt ordered alloy oriented perpendicular to the film surface is obtained by using MgO for the underlayer.

Further, the [100] axis of MgO is longer than each crystal axis of the L1₀-type FePt ordered alloy and the FePt disordered alloy. Thus, when a FePt alloy is deposited on MgO, tensile stress occurs in the lateral direction of the FePt alloy. The tensile stress is a driving force for orienting the [001] axis of the L1₀-type FePt ordered alloy perpendicular to the film surface as well as a driving force for ordering. From the point of view of the above, MgO is very suitable for the underlayer material of the thin film of the L1₀-type FePt ordered alloy.

As an example of the background art in the technical field of the present invention, JP Patent Publication (Kokai) No. 2001-101645 A is cited here. This patent publication describes the PROBLEM TO BE SOLVED as “to provide an information recording medium achieving high reproducing output and high resolution in high density information recording, especially in magnetic recording” and discloses a technique “in which an information recording medium having a layer made of a soft magnetic material, a layer made of a nonmagnetic material, and an L1₀-type ordered alloy information recording layer selected from a group A which are sequentially formed in this order, is manufactured by a specified method. The group A consists of a FePt ordered alloy, a CoPt ordered alloy or a FePd ordered alloy and an alloy consisting thereof” and MgO is described as “the layer made of a nonmagnetic material”.

As another example of the background art in the technical field of the present invention, JP Patent Publication (Kokai) No. 2003-173511 A is cited here. This patent publication describes the PROBLEM TO BE SOLVED as “to provide a high density magnetic recording medium having excellent thermal stability and reduced noise” and discloses a technique “in which the magnetic recording medium has a first orientation control layer, a second orientation control layer, a soft magnetic layer, a nonmagnetic layer, a recording layer, and a carbon overcoat on a substrate. The recording layer is made of an L1₀ ordered alloy phase exhibiting ferromagnetism and a FePt₃ ordered alloy phase exhibiting paramagnetism” and MgO is described as “the nonmagnetic layer”.

As still another example of the background art in the technical field of the present invention, JP Patent Publication (Kohyo) No. 2008-511946 A is cited here. This patent publication discloses “a recording medium for perpendicular magnetic recording comprising a soft magnetic underlayer (SUL) having a first crystalline orientation; and a second magnetic film, wherein the second magnetic film is induced so as to be epitaxially grown from the SUL in a second crystalline orientation by controlling the first crystalline orientation”. This patent publication further discloses a technique “further comprising a buffer layer between the SUL and the underlayer” and the buffer layer is made of MgO.

### SUMMARY OF THE INVENTION

As described above, MgO has an effect of controlling the crystalline orientation of an L1₀-type FePt ordered alloy and promoting the ordering thereof, and hence is very suitable for the underlayer material. In order to use an L1₀-type FePt ordered alloy for a magnetic recording layer of the magnetic recording medium, it is very preferable that the MgO underlayer is arranged immediately under the magnetic recording layer.

The magnetic recording medium for use in a hard disk drive is manufactured by a sputtering method. Since MgO is a nonconductor, a DC sputtering method cannot be used, but only an RF sputtering method can be used as the sputtering method of depositing MgO. The RF sputtering method generally has a deposition rate lower than the DC sputtering method. Particularly, when a nonconductor film is formed, the deposition rate of the RF sputtering method is remarkably low.

The magnetic recording medium for use in a hard disk drive is manufactured by sequentially depositing each layer thereof by an inline-type sputtering apparatus including a plurality of film deposition chambers in the mass production process. Accordingly, if the deposition rate of a part of the layers is low, the deposition time thereof becomes a bottleneck, which reduces manufacturing throughput. The standard manufacturing throughput of a current magnetic recording medium for use in a hard disk drive is several hundred pieces per hour and the time required to form each layer (takt time) is about six seconds or less depending on the apparatus to be used. Accordingly, when a nonconductor such as MgO is formed by an RF sputtering method, a thick layer thereof cannot be deposited by the mass production process. The maximum deposition rate of the MgO sputtering is about 0.5 nm/s at most no matter how the film deposition conditions are adjusted. Since the takt time allowed for film deposition of each layer is six seconds or less, an MgO layer having a thickness in excess of 3 nm cannot be formed by the mass production process.

When an MgO underlayer having a thickness of 3 nm or less is independently formed, it is difficult to obtain good crystalline orientation although the [001] axis of MgO has a tendency of being easily oriented perpendicular to the film surface. In order to independently form an MgO underlayer and obtain good crystalline orientation, a thickness of about 10 nm was required for the MgO underlayer according to the results of a study by the present inventors. Thus, in order to use an MgO underlayer having a thickness of 3 nm or less, another layer having a role of promoting film surface perpendicular orientation of the [001] axis of the MgO underlayer needs to be provided at the bottom of the MgO underlayer to form a multilayered underlayer.

As described above, in order to cause the FePt alloy to be ordered, the heating process at a temperature in excess of 300° C. is required. Each atom constituting a metal is associated with each other only by a weak metallic bond. Thus, when energized by such a heating process, each metal atom is easily dissociated and diffused in the solid. When metal is used as the material of the layer provided at the bottom of the MgO layer in the multilayered underlayer, each metal atom is transmitted through the MgO layer having a small thickness and is diffused in the magnetic recording layer, thereby remarkably deteriorating the magnetic properties. Any of the JP Patent Publication (Kokai) No. 2001-101645 A, the JP Patent Publication (Kokai) No. 2003-173511 A, and the JP Patent Publication (Kohyo) No. 2008-511946 A, discloses an example of a magnetic recording medium configured to provide another metal layer at the bottom of an MgO underlayer with a thickness of 1 nm, but the problem of metal atom diffusion occurring during the heating process is not sufficiently considered.

In view of the above problem, it is an object of the present invention to provide a magnetic recording medium including an MgO underlayer that can be formed by a mass production process and has a thickness of 3 nm or less as well as including a magnetic recording layer made of an L1₀-type FePt ordered alloy having excellent magnetic properties.

The present inventors have made zealous studies and have found that the above object can be achieved by using a conductive compound having a crystal structure belonging to a cubic system as the material of the underlayer provided at the bottom of the MgO underlayer.

The magnetic recording medium according to the present invention is a high density magnetic recording medium including a magnetic recording layer made of an L1₀-type FePt ordered alloy having a high magnetic anisotropy constant and can be mass-produced at high throughput.

### BRIEF DESCRIPTION OF THE DRAWINGS

FIG. 1 illustrates a crystal structure of an L1₀-type FePt ordered alloy.

FIG. 2 illustrates a crystal structure of MgO.

FIG. 3 illustrates a sectional structure of a magnetic recording medium 10.

FIG. 4 is a graph illustrating the results of measuring a magnetization loop of the magnetic recording medium 10 according to a first example.

FIG. 5 is a graph illustrating the results of measuring an X-ray diffraction pattern of the magnetic recording medium 10 according to the first example.

FIG. 6 is graphs plotting the saturation magnetization, the coercivity, the magnetic anisotropy constant, the order parameter, the crystalline orientation randomness, and the grain diameter of the magnetic recording medium 10 according to a second example with respect to the thickness of an MgO underlayer 130.

FIG. 7 is a table listing the values of the coercivity, the magnetic anisotropy constant, and the crystalline orientation randomness of the magnetic recording medium 10 according to the first, third, and fourth examples.

FIG. 8 is a table listing the values of the coercivity, the magnetic anisotropy constant, the order parameter, the crystalline orientation randomness, and the grain diameter of the magnetic recording medium 10 according to the first, tenth, and eleventh examples.

FIG. 9 is a graph illustrating a magnetization loop of a magnetic recording medium according to a first comparative example.

FIG. 10 is a graph illustrating an X-ray diffraction pattern of the magnetic recording medium according to the first comparative example.

FIG. 11 is graphs plotting the saturation magnetization, the coercivity, the magnetic anisotropy constant, the order parameter, and the crystalline orientation randomness of the magnetic recording medium according to a second comparative example with respect to the thickness of the MgO underlayer 130.

FIG. 12 is a graph illustrating a magnetization loop of a magnetic recording medium according to a third comparative example.

FIG. 13 is a graph illustrating an X-ray diffraction pattern of the magnetic recording medium according to the third comparative example.

FIG. 14 is graphs plotting the saturation magnetization, the coercivity, the magnetic anisotropy constant, the order parameter, and the crystalline orientation randomness of the magnetic recording medium according to a fourth comparative example with respect to the thickness of the MgO underlayer 130.

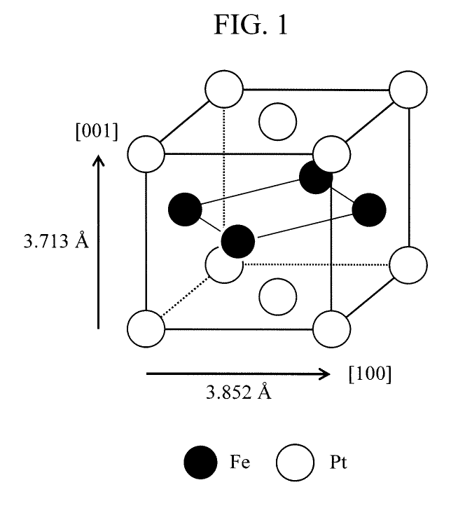

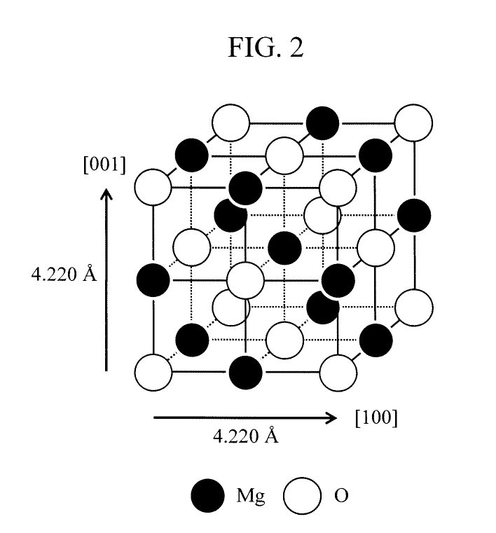

### DETAILED DESCRIPTION OF THE PREFERRED EMBODIMENTS

Now, preferred embodiments of the present invention will be described referring to the accompanying drawings.

FIG. 3 illustrates a sectional structure of a magnetic recording medium 10 according to the present invention. The magnetic recording medium 10 includes a substrate 100, on which an adhesion layer 110, a conductive compound layer 120, an MgO underlayer 130, and a magnetic recording layer 140 are deposited in this order. The upper surface of the magnetic recording layer 140 is covered with an overcoat 150, and a lubricant layer 160 is applied to the upper surface of the overcoat 150. Note that the present invention is not limited to this embodiment, but another layer made of a different material can be further added and deposited between the substrate 100 and the adhesion layer 110, between the adhesion layer 110 and the conductive compound layer 120, or on the upper portion of the magnetic recording layer 140.

The material of the substrate 100 is, for example, glass. Note that, for example, Al, Al₂O₃, MgO, Si, or the like may be used as the material of the substrate 100 as long as the material is a nonmagnetic material of high rigidity. The material of the adhesion layer 110 is, for example, Ta, Ti, or an alloy containing these elements. The material of the adhesion layer 110 is preferably amorphous so as not to affect the crystalline orientation of a layer deposited thereon. The material of the overcoat 150 is, for example, diamond-like carbon, carbon nitride, silicon nitride, or the like. The material of the lubricant layer 160 is, for example, perfluoropolyether, fluorinated alcohol, fluorinated carboxylic acids, or the like.

The conductive compound layer 120 has a crystal structure belonging to a cubic system and is made of a compound such as a conductive oxide, nitride, and carbide. When a thin film is made of the conductive compound, like MgO, the crystalline orientation is determined so as to minimize the surface energy, and the [001] axis is preferentially oriented perpendicular to the film surface. This conductive compound and MgO have a similar crystal structure, and hence the film surface perpendicular orientation of the [001] axis of the MgO underlayer 130 is promoted by providing the conductive compound layer 120 at the bottom of, particularly immediately under the MgO underlayer 130.

The conductive compound layer 120 can be formed by a DC sputtering method, and hence the deposition rate can be sufficiently increased. Therefore, even if the takt time allowed for the mass production process is six seconds or less, the conductive compound layer 120 with a large thickness in excess of 10 nm can be easily formed.

The material of the conductive compound layer 120 is, for example, preferably strontium titanate, indium tin oxide, or titanium nitride. The indium tin oxide and the titanium nitride are conductive compounds. The strontium titanate is expressed by a chemical formula of SrTiO₃. The strict stoichiometric composition thereof is a nonconductor, but the strontium titanate can be easily conductive by adding a very small amount of ternary element or by introducing oxygen vacancies.

Each atom in a compound is generally associated with each other only by a very strong covalent bond. Thus, unlike a metal in which each atom is associated with each other by a weak metallic bond, the conductive compound layer 120 itself is hardly dissociated and diffused. Thus, when the conductive compound layer 120 is provided at the bottom of the MgO underlayer 130 with a thickness of 3 nm or less, it is extremely unlikely to occur that the atoms constituting the conductive compound layer 120 are transmitted through the MgO underlayer 130 and diffused up to the magnetic recording layer 140.

The MgO underlayer 130 has a thickness of 1 nm or more and 3 nm or less. When the thickness thereof is less than 1 nm, the thickness is too small to form a continuous film in a lateral direction, which is not preferable. As described above, the maximum deposition rate of the MgO sputtering is about 0.5 nm/s at most no matter how the film deposition conditions are adjusted. In the current mass production process for a magnetic recording medium for use in a hard disk drive, takt time allowed for film deposition of each layer is six seconds or less and the thickness in excess of 3 nm cannot be adapted to mass production, which is not preferable.

The magnetic recording layer 140 includes an L1₀-type FePt ordered alloy. In order to promote ordering of the L1₀-type FePt ordered alloy, Ag, Au, Cu, or the like may be added to the magnetic recording layer 140. In order to obtain a structure (granular structure) preferable for the magnetic recording layer 140 in which fine magnetic crystal grains are isolated from each other by grain boundaries, an oxide such as SiO₂, MgO, Ta₂O₅ or a nonmetallic element such as carbon may be added to the magnetic recording layer 140 as a material segregating into the grain boundaries of the magnetic crystal grains.

Note that in the magnetic recording layer 140 according to the present invention, even if the L1₀-type ordered structure partially collapses and the completely ideal L1₀-type ordered alloy is not formed, the portion having the L1₀-type ordered structure is considered to exert certain effects. Note also that the following description focuses mainly on an example of using an FePt ordered alloy for the magnetic recording layer 140, but any combination of the ordered alloys (Fe or Co) and (Pt or Pd) is considered to exert similar effects.

The magnetic recording apparatus manufactured using the magnetic recording medium 10 according to the present invention can increase the recording density and, as a result, can meet the demand for a large capacity magnetic recording apparatus.

Now, referring to examples, the embodiment of the present invention will be described in detail. Note that the following examples are just for illustrative purposes for ease of understanding of the present invention and are not intended to limit the present invention unless otherwise noted.

### First Example

The magnetic recording medium 10 was manufactured in such a manner that a heat-resistant glass was used to form the substrate 100; an Ni—Ta layer with a thickness of 100 nm was formed thereon as the adhesion layer 110; a strontium titanate layer with a thickness of 12 nm was formed thereon as the conductive compound layer 120; the MgO underlayer 130 with a thickness of 1 nm was formed thereon; a 70 vol % (45 at % Fe-45 at % Pt-10 at % Ag)-30 vol % C layer with a thickness of 6 nm was formed thereon as the magnetic recording layer 140; and a carbon nitride layer with a thickness of 4 nm was formed thereon as the overcoat 150 in a sequential manner. The time required to form the MgO underlayer 130 with a thickness of 1 nm was 2.0 seconds.

An inline high-speed disk sputtering system (C-3010) manufactured by Canon ANELVA Corporation for use in mass production of a magnetic recording medium for a hard disk drive was used to manufacture the magnetic recording medium 10 according to the first example. The system included a plurality of film deposition chambers, a heater chamber for heating, and a substrate load/unload chamber and each chamber was evacuated independently of each other. The system was used to move a carrier with the substrate 100 placed thereon to each chamber and the film deposition and heating processes were sequentially performed to manufacture the magnetic recording medium 10 of the first example. The heater chamber was placed before the film deposition chamber of the magnetic recording layer 140. In a state in which the substrate 100 was preliminarily heated, the magnetic recording layer 140 was formed to obtain the magnetic recording layer 140 containing the L1₀-type FePt ordered alloy. A PBN (pyrolytic boron nitride) heater was used to heat both surfaces of the substrate 100. The heater power and the heating time were adjusted so as to obtain an average substrate temperature of 450° C. during the period when the magnetic recording layer 140 was formed.

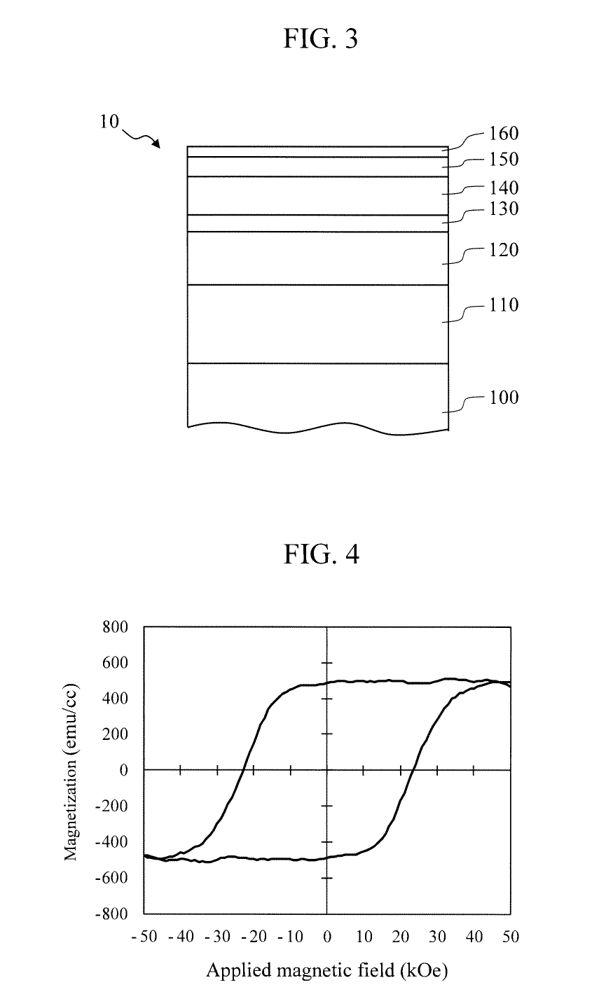

FIG. 4 is a graph illustrating the results of measuring the magnetization loop of the magnetic recording medium 10 according to the first example. A vibrating sample magnetometer serving as torque magnetometer (TM-TRVSM-5050) manufactured by Tamakawa was used for measurement. It is understood from FIG. 4 that the magnetization loop having high coercivity and good squareness was obtained. The saturation magnetization and the coercivity of the magnetic recording medium 10 were 510 emu/cc and 23 kOe respectively. The magnetic torque curve was measured and the magnetic anisotropy constant of the magnetic recording medium was calculated to obtain 1.7×10⁷ erg/cc.

The coercivity of a current magnetic recording medium is several kOe at most, and the magnetic anisotropy constant thereof is in the low 10⁶ erg/cc range. The magnetic recording medium 10 of the first example had several times greater coercivity and magnetic anisotropy constant than the current magnetic recording medium and exhibited excellent magnetic properties.

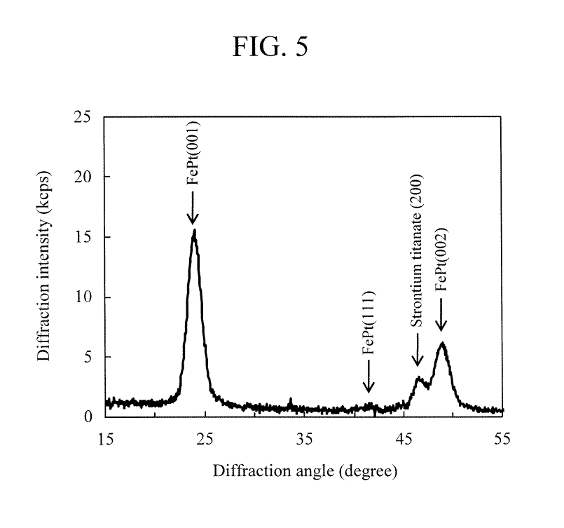

FIG. 5 is a graph illustrating the results of measuring the X-ray diffraction pattern of the magnetic recording medium 10 according to the first example. Based on the results of the measurement, the crystalline orientation of the magnetic recording medium 10 according to the first example was evaluated. A horizontal sample mounting X-ray diffractometer (Smart Lab) manufactured by Rigaku Corporation was used for measurement.

As the diffraction peak indexed to the FePt alloy, the diffraction peaks from (001) and (002) crystal planes were strongly observed. The results indicate that the [001] axis of the FePt alloy were oriented perpendicular to the film surface in a substantially complete manner. If the film surface perpendicular orientation of the [001] axis of the FePt alloy were not good, the diffraction from the (111) crystal plane would have been clearly observed, but a very small amount of diffraction from the (111) crystal plane was observed.

Diffraction from the (002) crystal plane appears regardless of whether the FePt alloy is a disordered alloy or an ordered alloy, while diffraction from the (001) crystal plane appears only when the FePt alloy is an L1₀-type ordered alloy. Specifically, the measurement results illustrated in FIG. 5 indicate that the magnetic recording layer 140 of the magnetic recording medium 10 according to the first example contained the L1₀-type FePt ordered alloy with the axis oriented perpendicular to the film surface. Therefore, the excellent magnetic properties of the magnetic recording medium 10 according to the first example is considered to be obtained because the magnetic recording layer 140 contained therein the L1₀-type FePt ordered alloy with the [001] axis oriented perpendicular to the film surface.

A parameter called the order parameter indicative of the degree of ordering of ordered alloys can be calculated from the X-ray diffraction pattern. The order parameter is calculated using a diffraction intensity ratio from the (001) and (002) crystal planes. The order parameter indicates the ratio of the number of atoms occupying the ideal atomic arrangement of ordered alloys. When the order parameter is 1, it means an ideal ordered arrangement of atoms; when the order parameter is 0, it means a completely disordered arrangement of atoms. The order parameter of the magnetic recording medium 10 according to the first example was substantially 1.

In order to observe the microstructure of the magnetic recording medium 10 according to the first example in detail, a high resolution transmission electron microscope (H-9000UHR) manufactured by Hitachi High-Technologies Corporation having compositional analysis capabilities by energy dispersive X-ray spectroscopy was used. When the plan-view structure of the magnetic recording layer 140 was observed, it was confirmed that the crystal grains consisting of Fe, Pt, and Ag were clearly separated by the grain boundaries consisting of C to form a granular structure. The average diameter of the crystal grains (hereinafter simply referred to as a grain diameter) was 6.4 nm. As a result of compositional analysis of the magnetic recording layer 140, it was confirmed that no metal element other than Fe, Pt, and Ag was detected and the atoms constituting the MgO underlayer 130, the conductive compound layer 120, or the adhesion layer 110 were not diffused into the magnetic recording layer 140.

### Second Example

The second example of the present invention used the same method as that of the first example except that the thickness of the MgO underlayer 130 was variously changed to manufacture a plurality of magnetic recording media 10. The characteristics of these magnetic recording media 10 were evaluated by the same method as that of the first example.

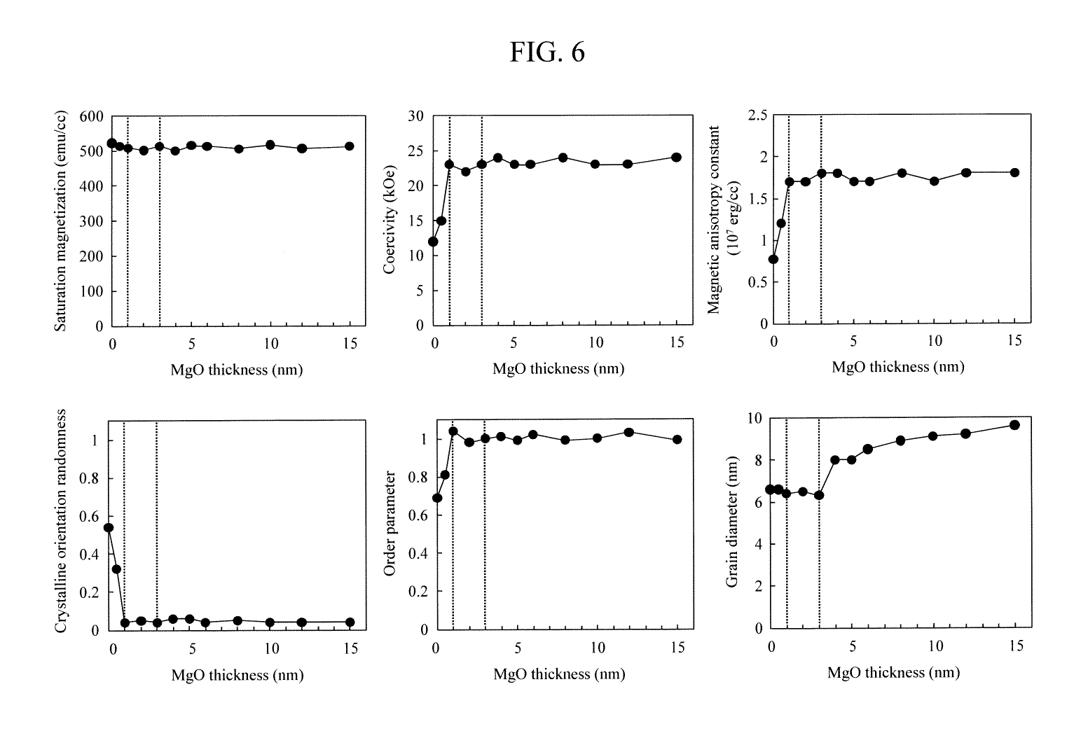

FIG. 6 is graphs plotting the saturation magnetization, the coercivity, the magnetic anisotropy constant, the order parameter, the crystalline orientation randomness, and the grain diameter of the magnetic recording media 10 according to the second example with respect to the thickness of the MgO underlayer 130. Here, the crystalline orientation randomness is defined as a diffraction peak intensity from the (111) crystal plane normalized by a diffraction peak intensity from the (002) crystal plane in the X-ray diffraction pattern. A larger value means that the film surface perpendicular orientation of the [001] axis is incomplete.

When the thickness of the MgO underlayer 130 was 1 nm or more and 3 nm or less, the characteristics of the magnetic recording medium 10 were almost unchanged; and good magnetic properties and crystalline orientation, and fine grain diameters were obtained at any thickness of the MgO underlayer 130.

When the thickness of the MgO underlayer 130 is less than 1 nm, the coercivity, the magnetic anisotropy constant, and the order parameter were remarkably reduced and the crystalline orientation randomness was increased in comparison with the case in which the thickness of the MgO underlayer 130 was 1 nm or more and 3 nm or less. A possible reason for this is that the thickness of the MgO underlayer 130 was too small to form a continuous film in a lateral direction, which impaired the functions for appropriately controlling the crystalline orientation of the magnetic recording layer 140 and promoting the ordering. Particularly when the thickness of the MgO underlayer 130 was 0 nm, namely, when the magnetic recording layer 140 was directly deposited on the conductive compound layer 120, the characteristics were remarkably deteriorated. This indicates that although the MgO underlayer 130 and the conductive compound layer 120 had similar structure, the effects of controlling the crystalline orientation of the L1₀-type FePt ordered alloy and promoting the ordering were specific to the material of MgO. In any case, the saturation magnetization and the grain diameter were almost unchanged.

When the thickness of the MgO underlayer 130 was greater than 3 nm, the magnetic properties and the crystalline orientation randomness were almost the same when the thickness of the MgO underlayer 130 was 1 nm or more and 3 nm or less, but the grain diameter apparently tended to increase with an increase in thickness of the MgO underlayer 130. This increase in grain diameter is not preferable for the magnetic recording medium 10.

Thin film crystal grains generally grow into a columnar reverse pyramid shape and the grain diameter increases with an increase in thickness. The conductive compound layer 120, the MgO underlayer 130, and the magnetic recording layer 140 had a mutually similar crystal structure, and hence continuous crystal growth tended to occur between the layers. Therefore, naturally the grain diameter increased with an increase in thickness of the MgO underlayer 130.

Meanwhile, when the thickness of the MgO underlayer 130 was 1 nm or more and 3 nm or less, the grain diameter was almost unchanged. The reason for this can be considered as follows. These layers were somewhat different in characteristics such as the length of the crystal axis. Thus, some crystal grains did not grow continuously at an interface between these layers, which reduced the average grain diameter. When the MgO underlayer 130 with a small thickness is provided immediately under the magnetic recording layer 140, a grain diameter reduction effect occurred in two steps at the upper and lower interfaces of the MgO underlayer 130. This grain diameter reduction effect is considered to cancel the effect of increasing the grain diameter with an increase in thickness of the MgO underlayer 130.

When the thickness of the MgO underlayer 130 was greater than 3 nm, a time in excess of six seconds was required for film deposition thereof. In other word, the magnetic recording medium 10 of this case is not appropriate at all for the mass production process because the time required to form the MgO underlayer 130 becomes a bottleneck, which increases the takt time and reduces the manufacturing throughput.

### Third Example

The third example of the present invention used the same method as that of the first example except that a Cr layer with a thickness of 7 nm was added and formed as the orientation control layer between the adhesion layer 110 and the conductive compound layer 120 to manufacture the magnetic recording medium 10. The characteristics of this magnetic recording medium 10 were evaluated by the same method as that of the first example.

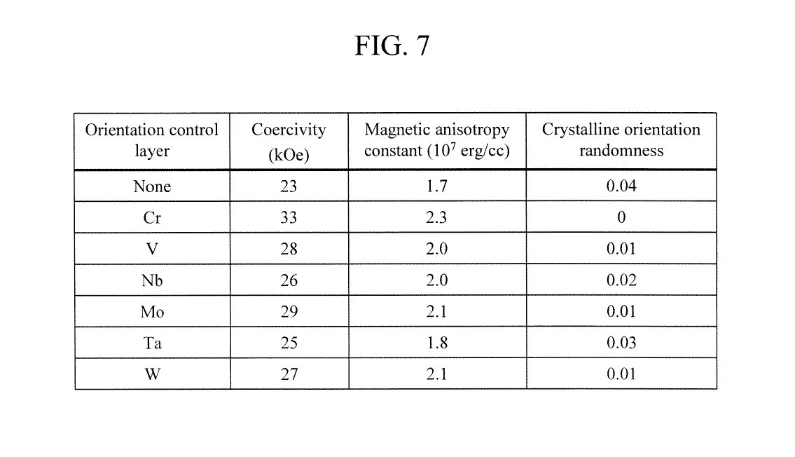

The first to second rows of FIG. 7 list the values of the coercivity, the magnetic anisotropy constant, and the crystalline orientation randomness of the magnetic recording media 10 according to the first example and the third example respectively. In the case of the magnetic recording medium 10 according to the first example (first row), a very small amount of diffraction peak from the (111) crystal plane of the FePt alloy was observed, while in the case of the magnetic recording medium 10 according to the third example, the diffraction peak from the (111) crystal plane completely disappeared. Specifically, the Cr layer with a thickness of 7 nm was added and formed as the orientation control layer between the adhesion layer 110 and the conductive compound layer 120, which further improved the film surface perpendicular orientation of the [001] axis of the magnetic recording layer 140. The reason for this can be considered as follows.

Cr has a body centered cubic structure. At an interface between the Cr layer and the conductive compound layer 120 having a crystal structure belonging to a cubic system, crystal growth was induced so as to match the [110] axis of Cr and the [100] axis of the conductive compound layer of the cubic system. Therefore, the Cr layer exhibited an effect of improving the film surface perpendicular orientation of the [001] axis of the conductive compound layer 120. Thus, the improvement in orientation of the conductive compound layer 120 is considered to have improved the orientation of the MgO underlayer 130 as well as the magnetic recording layer 140.

As a result of improvement in film surface perpendicular orientation of the [001] axis of the magnetic recording layer 140, the coercivity and the magnetic anisotropy constant increased and further excellent magnetic properties were obtained. Note that the saturation magnetization, the order parameter, and the grain diameter were almost the same as those of the magnetic recording medium 10 according to the first example. As a result of compositional analysis of the magnetic recording layer 140, it was confirmed that no metal element other than Fe, Pt, and Ag was detected and the atoms constituting the orientation control layer were not diffused into the magnetic recording layer 140.

### Fourth Example

The fourth example of the present invention used the same method as that of the third example except that the Cr layer was replaced with a V layer, an Nb layer, an Mo layer, a Ta layer, and a W layer (each having a thickness of 7 nm) as the orientation control layer to manufacture a plurality of magnetic recording media 10. The characteristics of these magnetic recording media were evaluated by the same method as that of the first example.

The third to seventh rows of FIG. 7 list the values of the coercivity, the magnetic anisotropy constant, and the crystalline orientation randomness of the magnetic recording media 10 according to the fourth example. In the case of the magnetic recording media 10 according to the fourth example, the diffraction peak from the (111) crystal plane did not completely disappear, but the values of the crystalline orientation randomness were decreased in comparison with the magnetic recording medium 10 according to the first example (first row). Any of V, Nb, Mo, Ta, and W has a body centered cubic structure, and hence is considered to have exerted orientation improvement effects by the same mechanism as that of Cr.

As a result of improvement in film surface perpendicular orientation of the [001] axis of the magnetic recording layer 140, the coercivity and the magnetic anisotropy constant increased and further excellent magnetic properties were obtained. Note that the order parameter and the grain diameter were almost the same as those of the magnetic recording medium 10 according to the first example. As a result of compositional analysis of the magnetic recording layer 140, it was confirmed that no metal element other than Fe, Pt, and Ag was detected and the atoms constituting the orientation control layer were not diffused into the magnetic recording layer 140.

Note that even if alloys containing any of Cr, V, Nb, Mo, Ta, and W are used to form an orientation control layer, the alloys are considered to exert the same effects as the third to fourth examples as far as the alloys have a body centered cubic structure.

### Fifth Example

The fifth example of the present invention used the same method as that of the first example except that the strontium titanate layer was replaced with an indium tin oxide layer with a thickness of 12 nm as the conductive compound layer 120 to manufacture the magnetic recording medium 10. The characteristics of this magnetic recording medium 10 were evaluated by the same method as that of the first example. The characteristics of the magnetic recording medium 10 according to the fifth example were almost similar to those of the magnetic recording medium 10 according to the first example. Specifically, it was confirmed that the indium tin oxide layer had a similar effect to the strontium titanate layer as the conductive compound layer 120.

### Sixth Example

The sixth example of the present invention used the same method as that of the first example except that the strontium titanate layer was replaced with a titanium nitride layer with a thickness of 12 nm as the conductive compound layer 120 to manufacture the magnetic recording medium 10. The characteristics of this magnetic recording medium 10 were evaluated by the same method as that of the first example. The characteristics of the magnetic recording medium 10 according to the sixth example were almost similar to those of the magnetic recording medium 10 according to the first example. Specifically, it was confirmed that the titanium nitride layer had a similar effect to the strontium titanate layer as the conductive compound layer 120.

### Seventh Example

The seventh example of the present invention used the same method as that of the third example except that perfluoropolyether was applied to an upper surface of the overcoat 150 as the lubricant layer 160 to manufacture the magnetic recording medium 10. Magnetic signals were written to and read from the magnetic recording medium 10 by a thermally assisted magnetic recording system. A static read-write tester was used for this read-write test.

The static read-write tester moves a magnetic head thereof over the static magnetic recording medium 10 and writes and reads magnetic signals at any positions. The magnetic head includes not only a magnetic pole and a coil normally provided to generate a recording magnetic field and a magnetoresistive effect device normally provided to read magnetic signals, but also a laser diode, a waveguide, a mirror, a near-field light generator, and the like. The magnetic head can write magnetic signals by applying a magnetic field while locally heating the magnetic recording layer 140 of the magnetic recording medium 10 by means of the near-field light.

Magnetic signals at various linear recording densities were written while optimizing the laser output, the laser irradiation time, the coil current, and the like and the written magnetic signals were read. As a result, a bit length resolution of 23.1 nm was obtained from the magnetic recording medium 10 according to the seventh example. This resolution converted to a linear recording density corresponds to a high recording density of 1100 kBPI (1100000 bits per inch).

### Eighth Example

The eighth example of the present invention used the same method as that of the seventh example except that an Ni—Ta layer with a thickness of 70 nm was formed as the adhesion layer 110, and an Fe—Co—Ta—Zr layer with a thickness of 30 nm was added and formed as the soft magnetic underlayer between the adhesion layer 110 and the orientation control layer to manufacture the magnetic recording medium 10. Magnetic signals were written to and read from the magnetic recording medium by a thermally assisted magnetic recording system in a similar way to that of the seventh example.

A bit length resolution of 19.0 nm was obtained from the magnetic recording medium 10 according to the eighth example. This resolution converted to a linear recording density corresponds to a high recording density of 1340 kBPI.

When a soft magnetic underlayer having properties of high saturation magnetic flux density and permeability was provided under the magnetic recording layer 140, the soft magnetic underlayer functioned as a path for a magnetic flux generated from the magnetic head, and hence a sharp perpendicular recording magnetic field was applied to the magnetic recording layer 140. Thus, the magnetic recording medium 10 according to the eighth example can exhibit more excellent record reproduction performance than the magnetic recording medium 10 according to the seventh example.

Note that even in the eighth example, the effect of providing the soft magnetic underlayer is considered to be similar to the case in which no orientation control layer is provided.

### Ninth Example

The ninth example of the present invention used the same method as that of the seventh example except that an Ni—Ta layer with a thickness of 70 nm was formed as the adhesion layer 110 and a Cu—Zr layer with a thickness of 30 nm was added and formed as a heat sink layer between the adhesion layer 110 and the orientation control layer to manufacture the magnetic recording medium 10. Magnetic signals were written to and read from the magnetic recording medium 10 by a thermally assisted magnetic recording system in a similar way to that of the seventh example.

A bit length resolution of 19.8 nm was obtained from the magnetic recording medium 10 according to the ninth example. This resolution converted to a linear recording density corresponds to a high recording density of 1280 kBPI.

In the thermally assisted magnetic recording system, the sharpness of magnetization switching in the magnetic recording layer 140 was affected not only by a recording magnetic field gradient from the head but also by a temperature gradient against time. When a heat sink layer having high thermal conductivity was provided under the magnetic recording layer 140, thermal diffusion in the magnetic recording layer 140 was promoted, which increased the temperature rising rate at the heat start time and the temperature lowering rate at the heat end time. Accordingly, a heat sink layer increased the sharpness of magnetization switching in the magnetic recording layer 140. Thus, the magnetic recording medium 10 according to the ninth example can exhibit more excellent record reproduction performance than the magnetic recording medium 10 according to the seventh example.

Note that the soft magnetic underlayer described in the eighth example may be provided together with the heat sink layer described in the ninth example. The soft magnetic underlayer and the heat sink layer are considered to exert corresponding effects regardless of which one is up and down. Note also that a single layer made of materials capable of exerting both functions of the soft magnetic underlayer and the heat sink layer can be used. Note also that the adhesion layer 110 and the orientation control layer can be made of materials capable of exerting functions of the soft magnetic underlayer and the heat sink layer to provide the adhesion layer 110 and the orientation control layer with a plurality of functions.

### Tenth Example

The tenth example of the present invention used the same method as that of the first example except that the 70 vol % (45 at % Fe-45 at % Pt-10 at % Ag)-30 vol % C layer was replaced with a 70 vol % (45 at % Fe-45 at % Pt-10 at % Ag)-30 vol % SiO₂ layer with a thickness of 6 nm as the magnetic recording layer 140 to manufacture the magnetic recording medium 10. The characteristics of this magnetic recording medium were evaluated by the same method as that of the first example.

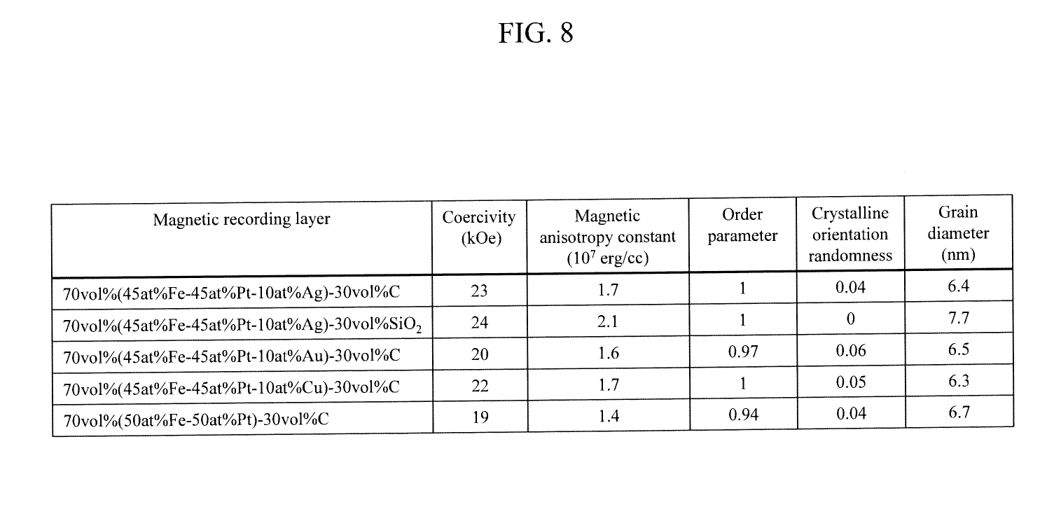

The first to second rows of FIG. 8 list the values of the coercivity, the magnetic anisotropy constant, the order parameter, the crystalline orientation randomness, and the grain diameter of the magnetic recording medium 10 according to the first example and the tenth example respectively. The magnetic recording medium 10 according to the tenth example exhibited high coercivity and magnetic anisotropy constant, and excellent magnetic properties. In comparison with the magnetic recording medium 10 according to the first example (first row), the crystalline orientation randomness decreased and the magnetic anisotropy constant increased. The coercivity was almost the same as that of the magnetic recording medium of the first example. A possible reason for this is that the grain diameter increased and the magnetization switching mode came close to the magnetic domain wall motion.

Note that in the tenth example, 30 vol % C was replaced with 30 vol % SiO₂ in the magnetic recording layer 140, but other oxides may be used. For example, MgO, Ta₂O₅, TiO₂, ZrO₂, or Al₂O₃ may be used. These oxides are for the purpose of effectively forming a granular structure in the magnetic recording layer 140. Thus, the other oxides may be used as long as the oxide exerts a similar effect.

### Eleventh Example

The eleventh example of the present invention used the same method as that of the first example except that 70 vol % (45 at % Fe-45 at % Pt-10 at % Ag)-30 vol % C layer was replaced with 70 vol % (45 at % Fe-45 at % Pt-10 at % Au)-30 vol % C layer with a thickness of 6 nm, 70 vol % (45 at % Fe-45 at % Pt-10 at % Cu)-30 vol % C layer with a thickness of 6 nm, or 70 vol % (50 at % Fe-50 at % Pt)-30 vol % C layer with a thickness of 6 nm as the magnetic recording layer 140 to manufacture the magnetic recording medium 10. The characteristics of this magnetic recording medium were evaluated by the same method as that of the first example.

The third to fifth rows of FIG. 8 list the values of the coercivity, the magnetic anisotropy constant, the order parameter, the crystalline orientation randomness, and the grain diameter of the magnetic recording medium 10 according to the eleventh example. The magnetic recording medium 10 according to the eleventh example exhibited high coercivity and magnetic anisotropy constant, and excellent magnetic properties.

In comparison with the magnetic recording medium 10 according to the first example (first row), when the 70 vol % (45 at % Fe-45 at % Pt-10 at % Cu)-30 vol % C layer was used as the magnetic recording layer 140, the characteristics thereof were almost the same as those of the first example. When the 70 vol % (45 at % Fe-45 at % Pt-10 at % Au)-30 vol % C layer was used as the magnetic recording layer 140, the order parameter slightly decreased, and accordingly the coercivity and the magnetic anisotropy constant also slightly decreased. When the 70 vol % (50 at % Fe-50 at % Pt)-30 vol % C layer was used as the magnetic recording layer 140, the order parameter, the coercivity, and the magnetic anisotropy constant further decreased.

It was found from the above results that Ag and Cu had a particularly high effect as an additive element for promoting the ordering of the L1₀-type FePt ordered alloy, and Au had an effect similar to Ag and Cu.

### First Comparative Example

The following first to fourth comparative examples focus on the configuration and the characteristics for comparing with the magnetic recording medium 10 according to the examples of the present invention.

The first comparative example used the same method as that of the first example except that the conductive compound layer 120 was not formed to manufacture the magnetic recording medium 10. The characteristics of this magnetic recording medium were evaluated by the same method as that of the first example.

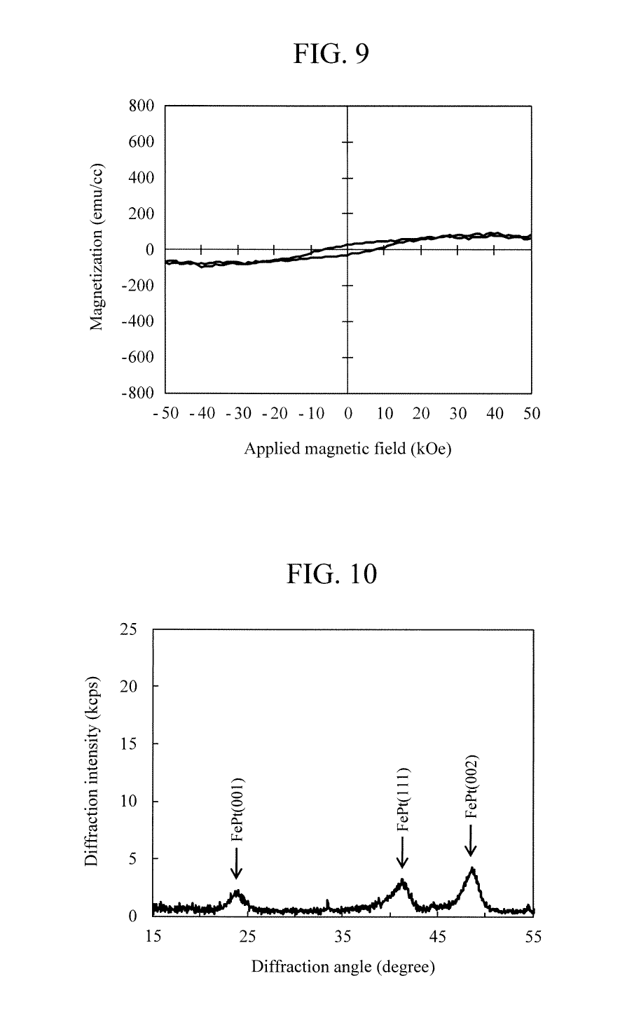

FIG. 9 is a graph illustrating a magnetization loop of a magnetic recording medium according to the first comparative example. The saturation magnetization and the coercivity of the magnetic recording medium were 80 emu/cc and 7 kOe respectively, which were remarkably lower than those of the magnetic recording medium 10 according to the first example.

FIG. 10 is a graph illustrating an X-ray diffraction pattern of the magnetic recording medium according to the first comparative example. In comparison with the magnetic recording medium 10 according to the first example, the diffraction peak intensity from the (001) and (002) crystal planes of the FePt alloy remarkably decreased and the diffraction peak intensity from the (111) crystal plane of the FePt alloy remarkably increased.

As a result of compositional analysis of the magnetic recording layer 140 according to the first comparative example, a lot of Ni and Ta were detected as the metal elements other than Fe, Pt, and Ag. The results indicate that metal atoms constituting the adhesion layer 110 were transmitted through the MgO underlayer 130 and diffused in the magnetic recording layer 140. These impurity elements contained in the magnetic recording layer 140 are considered to have impaired the ferromagnetism itself of the magnetic recording layer 140 and deteriorated not only the coercivity but also the saturation magnetization.

When the conductive compound layer 120 was not provided and the MgO underlayer with a thickness of 1 nm was independently used, the function of the MgO underlayer 130 for appropriately controlling the crystalline orientation of the magnetic recording layer 140 and promoting the ordering is assumed to have been impaired. That is the reason why the diffraction peak intensity from the (001) and (002) crystal planes of the FePt alloy decreased and the diffraction peak intensity from the (111) crystal plane of the FePt alloy increased.

### Second Comparative Example

The second comparative example used the same method as that of the first comparative example except that the thickness of the MgO underlayer 130 was variously changed to manufacture a plurality of magnetic recording media. The characteristics of these magnetic recording media were evaluated by the same method as that of the first example.

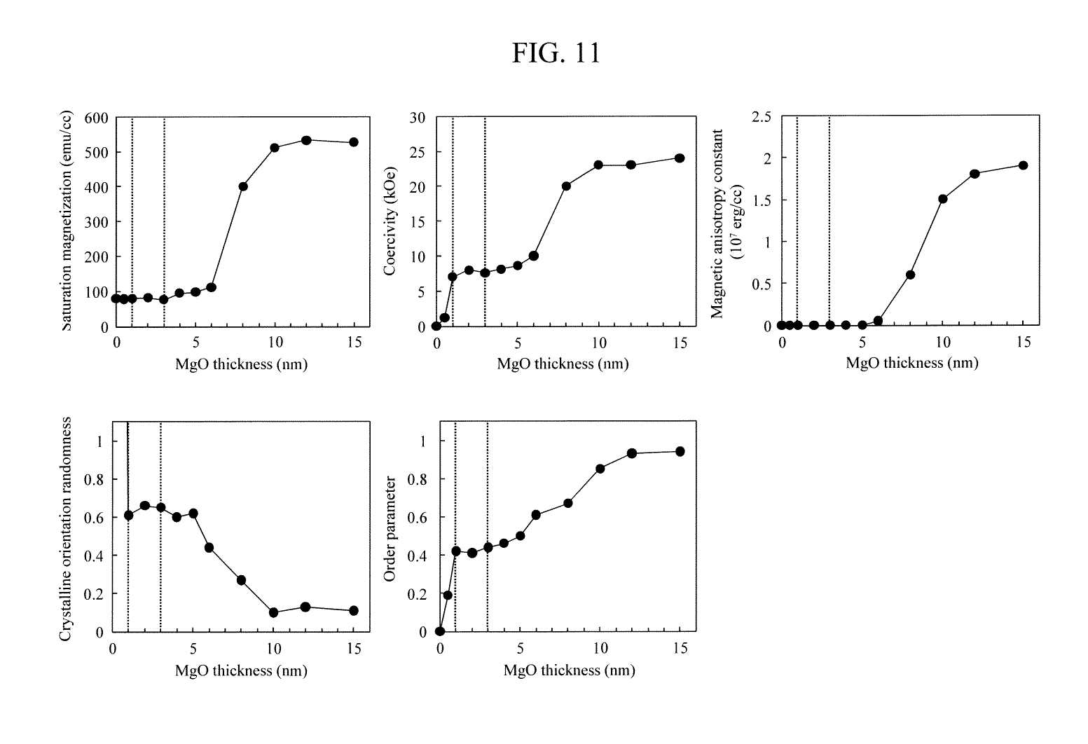

FIG. 11 is graphs plotting the saturation magnetization, the coercivity, the magnetic anisotropy constant, the order parameter, and the crystalline orientation randomness of the magnetic recording media according to the second comparative example with respect to the thickness of the MgO underlayer 130. When the conductive compound layer 120 was not provided and the MgO underlayer 130 was used independently, good crystalline orientation was not obtained unless the thickness of the MgO underlayer 130 was equal to or greater than about 10 nm. Further, the ordering was not promoted and hence excellent magnetic properties were not obtained. When the thickness of the MgO underlayer 130 was equal to or less than about 6 nm, particularly the magnetic properties were deteriorated. A possible reason for this is that metal atoms constituting the adhesion layer 110 were transmitted through the MgO underlayer 130 and diffused in the magnetic recording layer 140.

Note that when the thickness of the MgO underlayer 130 was greater than 3 nm, it took more than six seconds to form the MgO underlayer 130. In other word, the magnetic recording medium of this case is not appropriate at all for the mass production process because the time required to form the MgO underlayer 130 becomes a bottleneck, which increases the takt time and reduces the manufacturing throughput.

### Third Comparative Example

The third comparative example used the same method as that of the first example except that the conductive compound layer 120 was not formed and an orientation control layer made of a Cr layer was provided to manufacture the magnetic recording medium. The characteristics of this magnetic recording medium were evaluated by the same method as that of the first example.

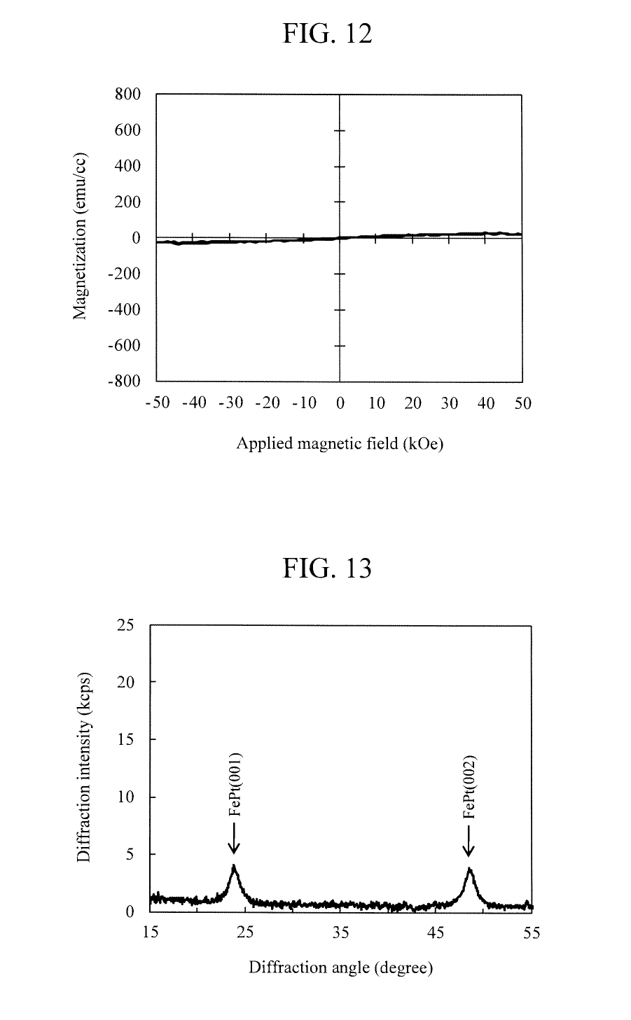

FIG. 12 is a graph illustrating a magnetization loop of a magnetic recording medium according to the third comparative example. The saturation magnetization and the coercivity of the magnetic recording medium were 50 emu/cc and 2 kOe respectively, which were remarkably lower than those of the magnetic recording medium 10 according to the first example.

FIG. 13 is a graph illustrating an X-ray diffraction pattern of the magnetic recording medium according to the third comparative example. In comparison with the magnetic recording medium 10 according to the first example, the diffraction peak intensity from the (001) and (002) crystal planes of the FePt alloy remarkably decreased.

As a result of compositional analysis of the magnetic recording layer 140 according to the third comparative example, particularly a lot of Cr was detected as the metal elements other than Fe, Pt, and Ag, and a small amount of Ni and Ta was also detected. The results indicate that metal atoms constituting the orientation control layer or the adhesion layer 110 were transmitted through the MgO underlayer 130 and diffused in the magnetic recording layer 140. These impurity elements contained in the magnetic recording layer 140 are considered to have impaired the ferromagnetism itself of the magnetic recording layer 140 and deteriorated not only the coercivity but also the saturation magnetization.

The magnetic recording medium of the third comparative example did not have the conductive compound layer 120, but had the Cr layer as the orientation control layer. Accordingly, the function of the MgO underlayer 130 for controlling the crystalline orientation of the magnetic recording layer 140 was not very much impaired and a clear deterioration of the crystalline orientation randomness did not occur.

### Fourth Comparative Example

The fourth comparative example used the same method as that of the third comparative example except that the thickness of the MgO underlayer 130 was variously changed to manufacture a plurality of magnetic recording media. The characteristics of these magnetic recording media were evaluated by the same method as that of the first example.

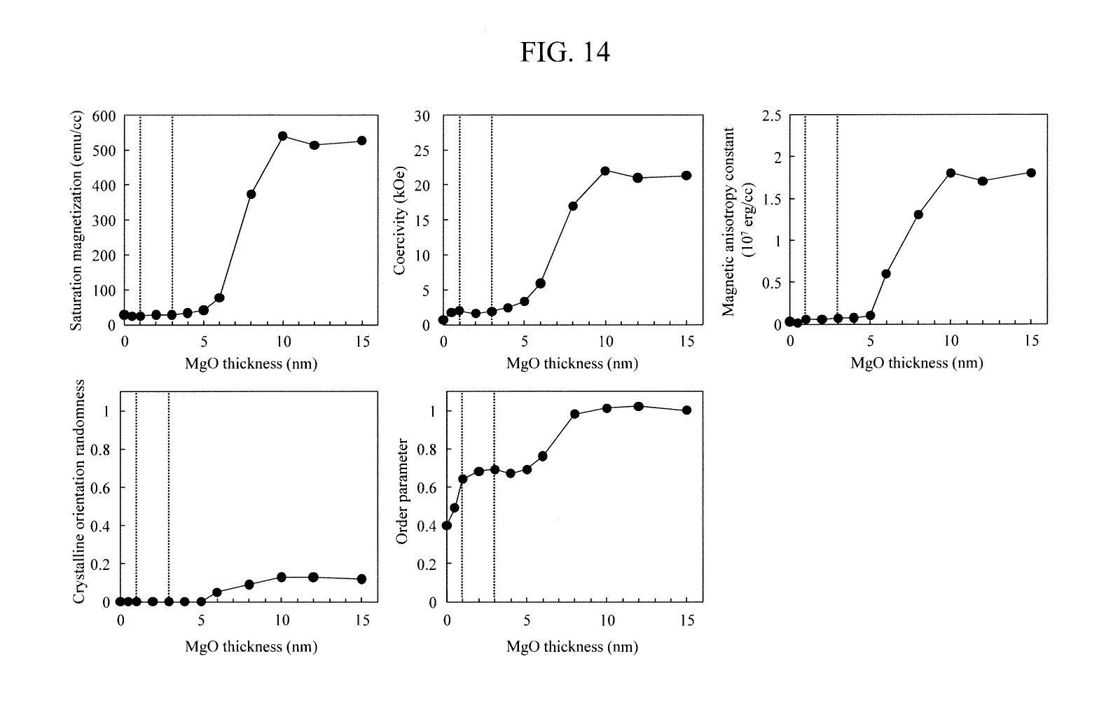

FIG. 14 is graphs plotting the saturation magnetization, the coercivity, the magnetic anisotropy constant, the order parameter, and the crystalline orientation randomness of the magnetic recording media according to the fourth comparative example with respect to the thickness of the MgO underlayer 130. In the fourth comparative example, the conductive compound layer 120 was not provided and the MgO underlayer 130 was directly in contact with the Cr layer as the orientation control layer. Thus, excellent magnetic properties were not obtained unless the thickness of the MgO underlayer 130 was equal to or greater than about 10 nm.

The magnetic recording media of the fourth comparative example are different from that of the second comparative example in that because of the benefit from the orientation control layer, the crystalline orientation was rather good despite a small thickness of the MgO underlayer 130, and the ordering was promoted to some degree. Nevertheless, excellent magnetic properties were not obtained. A possible cause for this is that Cr was diffused in the magnetic recording layer 140. In general, an element having a body centered cubic structure such as Cr remarkably impairs the ferromagnetism of a 3d ferromagnetic element. In the magnetic recording media according to the fourth comparative example, particularly the saturation magnetization was small when the thickness of the MgO underlayer 130 was equal to or less than about 6 nm. In the fourth comparative example, excellent magnetic properties were not obtained when the thickness of the MgO underlayer 130 was small. It is understood from the above results that a main cause for this is that Cr was diffused in the magnetic recording layer 140.

Note that when the thickness of the MgO underlayer 130 was greater than 3 nm, it took more than six seconds to form the MgO underlayer 130. In other word, the magnetic recording medium of this case is not appropriate at all for the mass production process because the time required to form the MgO underlayer becomes a bottleneck, which increases the takt time and reduces the manufacturing throughput.

### DESCRIPTION OF SYMBOLS

10 magnetic recording medium
100 substrate
110 adhesion layer
120 conductive compound layer
130 MgO underlayer
140 magnetic recording layer
150 overcoat
160 lubricant layer

What is claimed is:

1. A magnetic recording medium comprising:
a magnetic recording layer comprising an ordered alloy that is an ordered alloy having an L1₀-type structure and an alloy of one of Fe and Co and one of Pt and Pd;
an MgO layer arranged closer to a substrate than the magnetic recording layer is; and
a conductive compound layer that is arranged closer to the substrate than the MgO layer is and has a crystal structure belonging to a cubic system, wherein
the MgO layer has a thickness of 1 nm or more and 3 nm or less.

2. The magnetic recording medium according to claim 1, wherein the conductive compound layer includes any of strontium titanate, indium tin oxide, and titanium nitride.

3. The magnetic recording medium according to claim 1, further comprising a metal layer that is arranged closer to the substrate than the conductive compound layer is, has a body centered cubic structure, and comprises at least one element selected from a group consisting of Cr, V, Nb, Mo, Ta, and W.

4. The magnetic recording medium according to claim 1, wherein the magnetic recording layer comprises an oxide or carbon.

5. The magnetic recording medium according to claim 1, wherein the magnetic recording layer comprises at least one element selected from a group consisting of Ag, Au, and Cu.

6. The magnetic recording medium according to claim 1, further comprising a soft magnetic underlayer arranged closer to the substrate than the conductive compound layer is.

7. The magnetic recording medium according to claim 1, further comprising a heat sink layer arranged closer to the substrate than the conductive compound layer is.

8. A magnetic recording apparatus comprising the magnetic recording medium according to claim 1.
